(19) United States
(12) Patent Application Publication
(10) Pub. No.: US 2019/0141130 A1
(43) Pub. Date: May 9, 2019

(54) BOOTSTRAPPING A DISPERSED STORAGE NETWORK MEMORY WITH VIRTUAL DS UNITS

(71) Applicant: International Business Machines Corporation, Armonk, NY (US)

(72) Inventors: S. Christopher Gladwin, Chicago, IL (US); Michael D. O'Dell, Herndon, VA (US); Jason K. Resch, Chicago, IL (US)

(21) Appl. No.: 16/239,219

(22) Filed: Jan. 3, 2019

Related U.S. Application Data
(63) Continuation-in-part of application No. 15/686,980, filed on Aug. 25, 2017, now Pat. No. 10,180,880.
Application No. 15/686,980 is a continuation-in-part of application No. 14/287,499, filed on May 27, 2014, now Pat. No. 9,848,044.
(60) Provisional application No. 61/860,456, filed on Jul. 31, 2013.

(51) Int. Cl. H04L 29/08; G06F 11/10

(52) U.S. Cl. CPC H04L 67/1097; G06F 11/1012; G06F 11/1092

(57) ABSTRACT

A method includes receiving a request to commission a set of storage units for a DSN memory, where the request includes a DSN address range and dispersed data storage parameters that includes a pillar width number, and where the DSN address range is divided into the pillar width number of pillar address sub-ranges. The method continues with identifying storage units of the DSN to associate with the DSN address range to produce the set of storage units. The method continues with determining whether a number of storage units in the set of storage units is less than the pillar width number. When the number of the storage units is less than the pillar width number, the method continues with determining capability level information for each storage unit of the set of storage units and assigning the pillar width number of pillar address sub-ranges to the set of storage units.

### CROSS-REFERENCE TO RELATED APPLICATIONS

The present U.S. Utility patent application claims priority pursuant to 35 U.S.C. § 120 as a continuation-in-part of U.S. Utility application Ser. No. 15/686,980, entitled “ADAPTIVE REBUILDING RATES BASED ON SAMPLING AND INFERENCE,” filed Aug. 25, 2017, issuing as U.S. Pat. No. 10,180,880 on Jan. 15, 2019, which is a continuation-in-part of U.S. Utility application Ser. No. 14/287,499, entitled “DISTRIBUTED STORAGE NETWORK WITH COORDINATED PARTIAL TASK EXECUTION AND METHODS FOR USE THEREWITH,” filed May 27, 2014, issued as U.S. Pat. No. 9,848,044 on Dec. 19, 2017, which claims priority pursuant to 35 U.S.C. § 119(e) to U.S. Provisional Application No. 61/860,456, entitled “ESTABLISHING A SLICE REBUILDING RATE IN A DISPERSED STORAGE NETWORK,” filed Jul. 31, 2013, expired, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to initializing a DSN memory.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9A is a schematic block diagram of another embodiment of a distributed computing system in accordance with the present invention;

FIG. 9B is a diagram illustrating an example of a migration of virtual storage units within physical storage units in accordance with the present invention;

FIG. 10 is a flowchart illustrating an example of commissioning storage units in accordance with the present invention; and

FIG. 11 is a flowchart illustrating an example of commissioning a set of storage units for a dispersed storage network memory in accordance with the present invention.

### DETAILED DESCRIPTION OF THE INVENTION

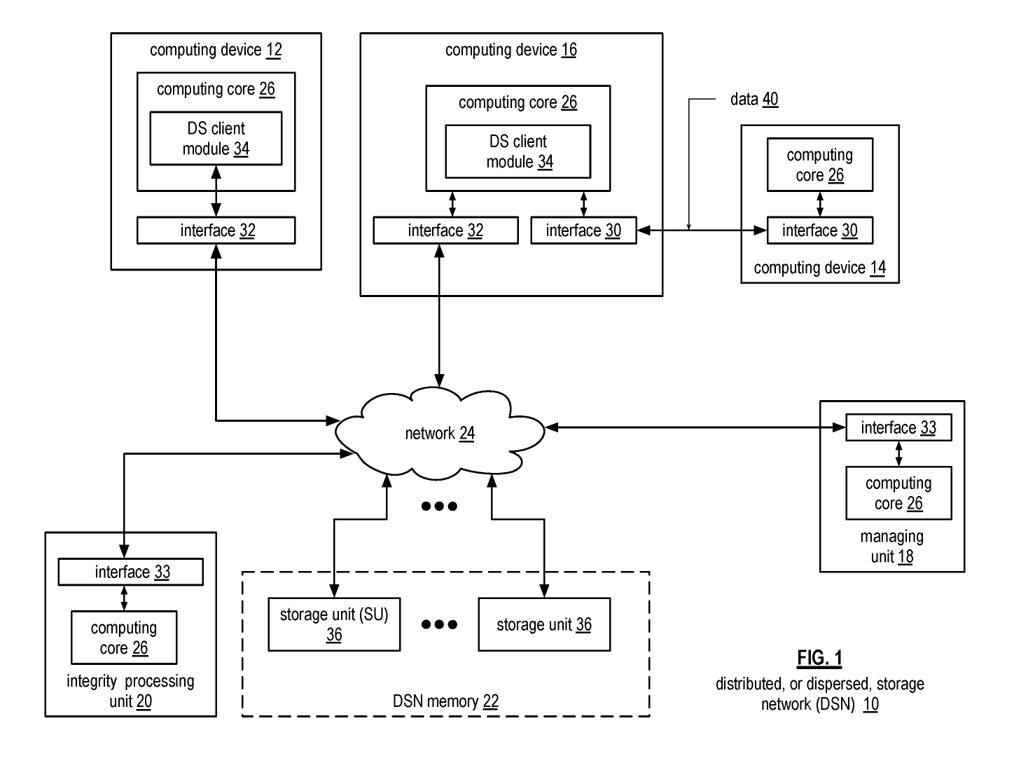

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

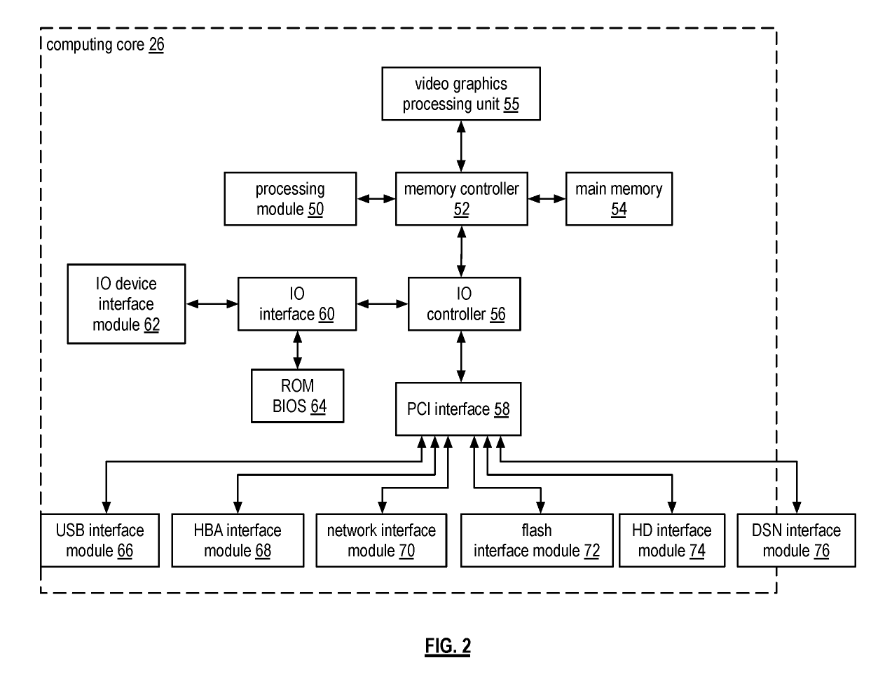

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data 40 on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSTN (distributed storage and task network) memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSTN managing unit 18 tracks the number of times a user accesses a non-public vault and/or public vaults, which can be used to generate per-access billing information. In another instance, the DSTN managing unit 18 tracks the amount of data stored and/or retrieved by a user device and/or a user group, which can be used to generate per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSTN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

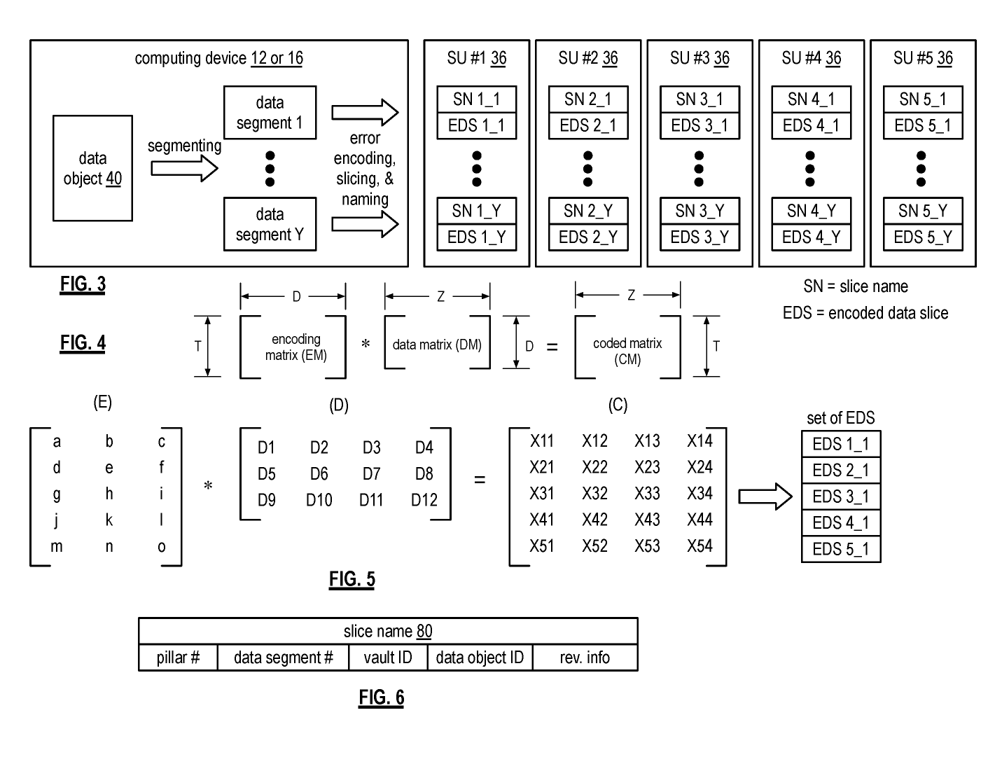

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

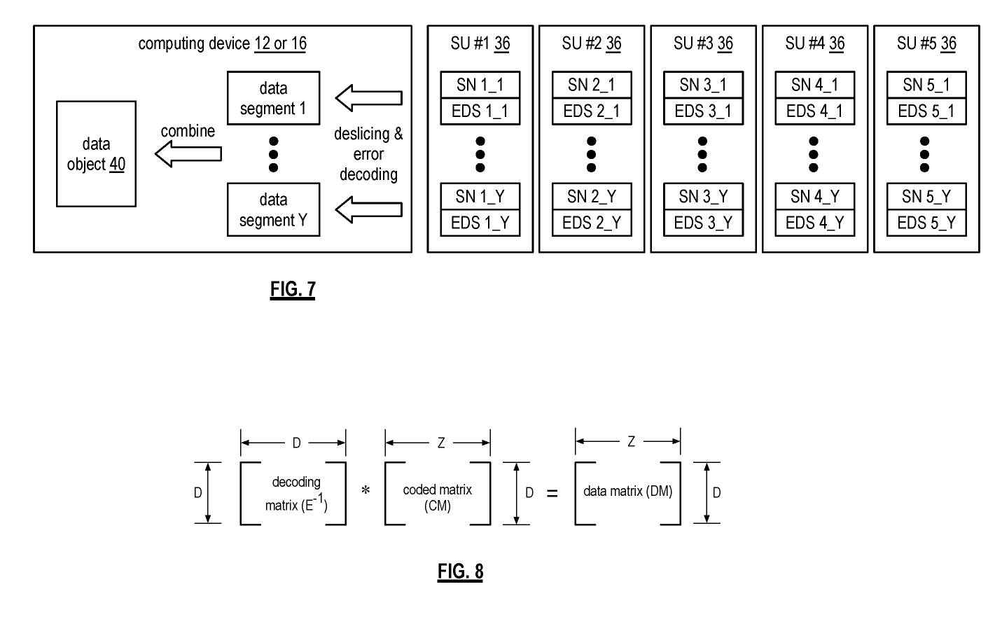

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

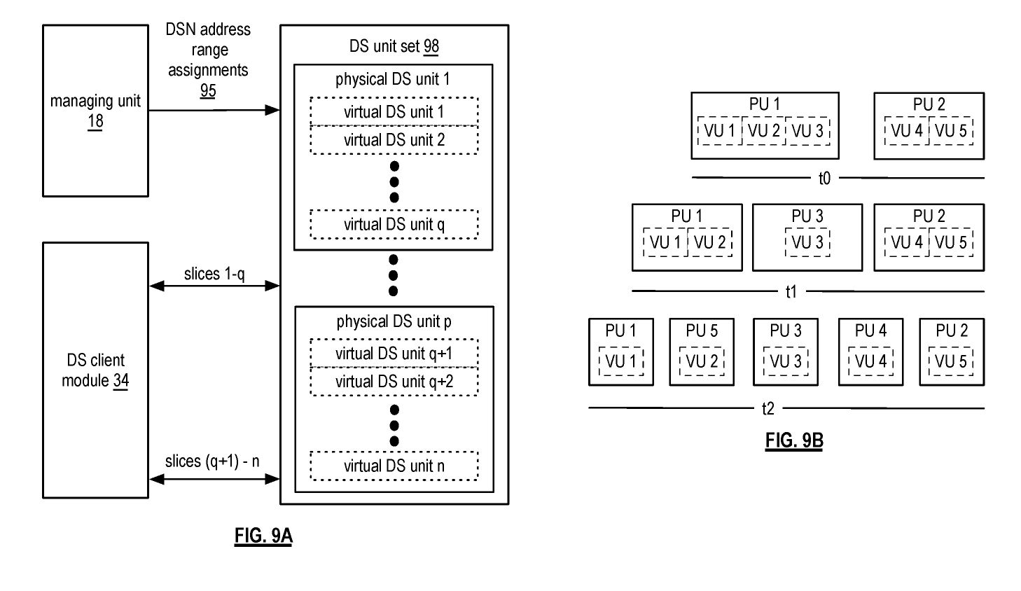

FIG. 9A is a schematic block diagram of another embodiment of a distributed or dispersed storage network system that includes a managing unit 18 (which may be implemented by a distributed storage and task network (DSTN) managing unit), a DS client module 34 (which may be implemented by a DST client module 34), and a DS unit set 98 (which may be implemented by a DST execution unit set). The DS unit set 98 includes one or more physical DS units 1-p. Each physical DS unit includes one or more virtual DS units of a set of virtual DS units 1-n. A virtual DS unit includes a logical implementation of functions of the storage unit 36 of FIG. 1. Each virtual DS unit is associated with a DSN address range assignment with regards to accessing encoded data slices associated with slice names that fall within the DSN address range assignment.

The managing unit 18 determines the DSN address ranges in accordance with storage capacity and processing capability of the physical DS units and forecasted storage loading and task processing loading. For example, the managing unit 18 assigns virtual DS units 1-3 to physical DS unit 1 when the storage capacity of the physical DS unit is greater than the forecasted storage loading for the three virtual DS units. As another example, the managing unit 18 assigns virtual DS units 4-5 to physical DST execution unit 2 when the processing capability of the physical DS unit 2 is greater than the forecasted task processing loading for the two virtual DS units.

The managing unit 18 issues DSN address range assignments to the physical DS units to establish the DSN address range assignment association with each virtual DS unit of each physical DS unit. For example, at a first timeframe to, the managing unit 18 issues the DSN address range assignments to assign three pillars of a common DSN address range to virtual DS units 1-3 of physical DS unit 1. For instance, a pillar 1 slices of the common DSN address range are assigned to virtual DS unit 1, pillar 2 slices of the common DSN address range are assigned to virtual DS unit 2, and pillar 3 slices of the common DSN address range are assigned to virtual DS unit 3. As another example, at the first timeframe to, the managing unit 18 issues additional DSN address range assignments to assign to more pillars of the common DSN address range to virtual DS units 1-2 of physical DS unit 2.

The DS client module 34 may access the DS unit set 98 in accordance with the DSN address range assignments to access encoded data slices stored within a set of virtual DS units. For example, the DS client module 34 sends an access request for pillars 1-3 of the common DSN address range to the physical DS 1 and sends remaining access requests for pillars 4-5 to physical DS unit 2 to access a set of encoded data slices associated with virtual DS units 1-3 within the physical DS unit 1 and virtual DS units 4-5 associated with physical DS unit 2.

In an example of operation, the managing unit 18 receives a request to commission a set of storage units for a DSN address range. The managing unit 18 identifies one or more physical storage units for the commissioning based on one or more of a manager input, storage unit availability information, a request, and a query response. The managing unit 18 determines capability level information for each of the one or more physical storage units. The capability level information includes one or more of available storage capacity, available task processing capability, current utilization levels, and forecasted utilization levels. The determining may be based on one or more of registry information, monitoring activity, performing a test, initiating a query, and receiving information.

The managing unit 18 determines mapping information (e.g., storage DSN address range, processing DSN address range) of a set of virtual storage units to the one or more physical storage units in accordance with the capability level information. The managing unit 18 issues DSN address range assignments to the one or more physical storage units that includes the mapping information.

When identifying an additional physical storage unit, the managing unit 18 determines updated mapping information based on updated capability level information. The managing unit 18 issues updated DSN address range assignments to update the one or more physical storage units that includes the updated mapping information. An example of updating assignment of virtual storage units to physical storage units is discussed in greater detail with reference to FIG. 9B.

In one embodiment, a dispersed storage network (DSN) memory is initialized using a limited number of dispersed storage (DS) units, where the number of DS units is less than the desired width (e.g., pillar width) of the information dispersal algorithm (IDA). For example, a DSN memory is created with two DS units and the IDA is chosen to have a pillar width of 16. To support normal operations, these initial DS units divide the responsibility of all 16 required (but not existent) DS units. These responsibilities (e.g., processing responsibilities) can include answering requests at certain network locations or addresses, responsibility for storing data across certain ranges of a global namespace, performing rebuilding operations for certain portions of the namespace, servicing dispersed authentication requests, and all other functions a DS unit would normally perform (e.g., responding to list requests, dispersed storage error encoding data, etc.). In this example, the two existing DS units may equally divide the responsibilities.

Alternatively, the two existing DS units may proportionally divide the responsibilities according to their available resources. For example, a DS unit A has 500 TB of storage, and DS unit B has 1500 TB of storage. In this example, DS unit B may take on the storage responsibilities of ¾ of the DSN memory (e.g., 16 pillar address sub-ranges of a DSN address range). Thus, for a system with a pillar width of 16, the DS unit B would fulfill the responsibilities of 12 of the 16 DS units (e.g., 12 pillar address subranges of 16 pillar address subranges) and DS unit A would fulfill the responsibilities of 4 of the DS units.

Continuing with the example, as more DS units are added to the set of storage units for the DSN address range, the responsibilities may be shifted or re-adjusted. This may require a migration of slices held by the DS units, and this may be performed over the network, by physically moving memory devices, or other through other methods. Further in this example, the system may implement separate storage and processing responsibilities. For example, DS unit B may be responsible to store 12 pillar address subranges, but is responsible for rebuilding operations for all 16 pillar address subranges. As another example, DS unit A may be responsible to authenticate a user device for access to any of the 16 pillar address subranges, while being responsible to store 4 of the 16 pillar address subranges.

FIG. 9B is a diagram illustrating an example of a migration of virtual storage units within physical storage units that includes mapping information of a set of virtual storage units (VU 1-5) to one or more physical storage units (PU 1-5). At a first timeframe t0, there are two available physical storage units to provide required storage capacity and task processing capacity. An initial mapping includes assignment of virtual storage units 1-3 to physical storage unit 1 and assignment of virtual storage units 4-5 physical storage unit 2.

At a second timeframe t1, there is an additional physical storage unit available to provide a total of three physical storage units. A next mapping includes assignment of virtual storage units 1-2 to physical storage unit 1, virtual storage unit 3 to physical storage unit 3 (e.g., virtual storage unit 3 slices are migrated to storage unit 3), and virtual storage units 4-5 remain mapped to physical storage unit 2 (e.g., not requiring slice migration).

At a third timeframe t2, there are two more additional physical storage units available to provide a total of five physical storage units. A next mapping includes assignment of one virtual storage unit to one physical storage unit. As a result, slices associated with virtual storage unit 2 are moved from physical storage unit 1 to physical storage unit 5, slices associated with virtual storage unit 4 are moved from virtual storage unit 2 to physical storage unit 4.

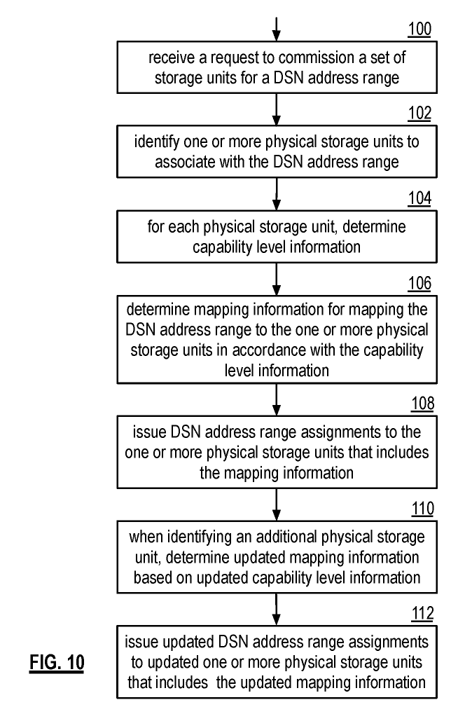

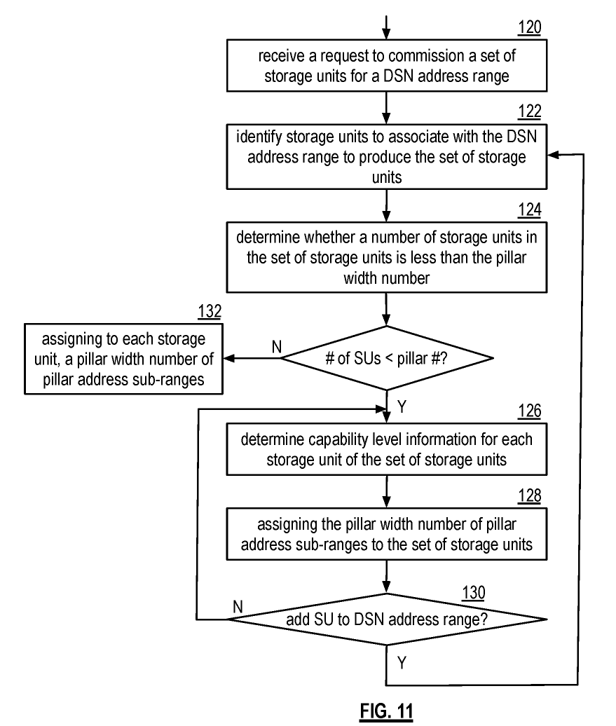

FIG. 10 is a flowchart illustrating an example of commissioning storage units. The method begins at step 100 where a processing module (e.g., of a distributed storage and task network (DSTN) managing unit, of a managing unit 18 of FIG. 1) receives a request to commission a set of storage units for a dispersed storage network (DSN) address range. The request includes one or more of the DSN address range, dispersal parameters (e.g., a pillar width number, read threshold number, etc.), identities of candidate physical storage units, forecasted storage loading levels, and forecasted task processing loading levels.

The method continues at step 102 where the processing module identifies one or more physical storage units to associate with the DSN address range. The method continues at step 104 where, for each physical storage unit, the processing module determines capability level information. The method continues at step 106 where the processing module determines mapping information for mapping the DSN address range to the one or more physical storage units in accordance with the capability level information. The determining includes identifying a pillar width number of DSN address sub-ranges (e.g., by pillar number) of the DSN address range. For each physical storage unit, the processing module allocates a storage DSN address sub-range and a processing DSN address sub-range of the DSN address range based on the capability level information of the one or more physical storage units. For each storage DSN address sub-range, the processing module allocates one or more DSN address sub-ranges. For each processing DSN address sub-range, the processing module allocates one or more of the DSN address sub-ranges.

The method continues at step 108 where the processing module issues DSN address range assignments for the one or more physical storage units that includes the mapping information. When identifying an additional physical storage unit, the method continues step 110 where the processing module determines updated mapping information based on updated capability level information. For example, the processing module detects the additional physical storage unit based on receiving a message. As another example, the processing module initiates updating capability level information (e.g., capability levels may have changed for one or more of the storage units).

The method continues at step 112 where the processing module issues updated DSN address range assignments to update one or more physical storage units that includes the updated mapping information. For example, the processing module sends the updated DSN address range assignments to each physical storage unit. As another example, the processing module sends the updated DSN address range assignments to physical storage units associated with changes between the mapping information and the updated mapping information. Alternatively, or in addition to, the processing module facilitates migrating the encoded data slices from a first physical storage unit to a second physical storage unit when a virtual storage unit has been reassigned from the first physical storage units of the second physical storage unit as a result of the updated mapping information.

FIG. 11 is a flowchart illustrating commissioning a set of storage units for a dispersed storage network (DSN) memory. The method begins at step 120, where a computing device of the DSN receives a request to commission a set of storage units for a DSN address range. The method continues with step 122, where the computing device identifies storage units to associate with the DSN address range to produce the set of storage units. The identifying may include one or more of utilizing a list of candidate storage units included in the request, obtaining storage unit availability information of the plurality of sets of storage units, receiving a query response from the plurality of sets of storage units that includes the capability level information of at least some storage units of the plurality of sets of storage units, and receiving a command. For example, the computing device identifies storage units for the set of storage units by receiving a list of candidate storage units in the request. As another example, the computing device identifies the storage units by sending a query request for availability information to a plurality of storage units of the DSN. The computing device receives a query response from at least some of the plurality of storage units that includes the availability the at least some storage units. The computing device then identifies DS units of the at least some storage units capable of servicing (e.g., within a processing latency threshold, etc.) the DSN address range.

The method continues with step 124, where the computing device determines whether a number of storage units in the set of storage units is less than the pillar width number. When the number of the storage units is less than the pillar width number, the method continues with step 126 where the computing device obtains capability level information for each storage unit of the set of storage units. The capability level information includes one or more of available storage capacity, available task processing capability, current utilization levels, and forecasted utilization levels.

The method continues with step 128, where the computing device assigns the pillar width number of pillar address sub-ranges to the set of storage units. The assigning may be based on one or more of the dispersed data storage parameters, the capability level information, and the number of the storage units. For example, the computing device assigns to a first storage unit of the set of storage units, two or more of the pillar address sub-ranges and assigns to remaining storage units of the set of storage units, remaining pillar address sub-ranges of the DSN address range, wherein the two or more pillar address sub-ranges and the remaining pillar address sub-ranges, collectively, are substantially the DSN address range.

In one example, a system begins with 3 storage units, a pillar width of 8 and a decode threshold of 5. The computing device divides a DSN address range by the pillar width number of 8 to produce 8 pillar address subranges (e.g., pillar address subranges 1-8). The computing device assigns to a first storage unit pillar address subranges 1-3, assigns to a second storage unit pillar address subranges 4-7 and assigns to a third storage unit pillar address subrange 8. In this example, the capability level information indicates that the first storage unit has forecasted utilization levels sufficient to service 3 pillar address subranges. Thus, the first storage unit is assigned pillar address subranges 1-3. The capability level information also indicates the second storage unit may handle responsibilities for all 8 pillar address subranges. However, the system may include a requirement to not store a read threshold number of encoded data slices on any one storage unit. In this instance, the second storage unit is assigned 4 pillar address subranges (e.g., pillar address subranges 4-7), which is less than the read threshold number of 5. The capability level information further includes storage availability information indicating that the third storage unit has the ability to service one pillar address subrange. Thus, the third storage unit is assigned pillar address subrange 8. Note other pillar address subrange assignments are possible depending on the individual needs of a DSN system.

The method continues with step 130, where the computing device determines whether to add an additional storage unit to the DSN address range. When yes, the method then loops back to step 122, where the computing device identifies additional storage units to associate with the DSN address range to produce the set of storage units (e.g., an updated set of storage units). In one example, the computing device may determine to add the additional storage units to replace one or more of the existing storage units of the set of storage units with one or more storage units of the additional storage units. When the number of the storage units is not less than the pillar width number the method continues with step 132, where the computing device assigns a pillar width number (e.g., one pillar width number) of the pillar address sub-range to each storage unit of the set of storage units. When no, the method may loop back to step 126, where the computing device may repeat determining capability level information for the set of storage units to produce updated capability level information.

In one embodiment, the computing device may use the updated capability level information to re-assign one or more pillar address sub-ranges within the set of storage units. For example, a system has dispersed data storage parameters that include a pillar width of 8 and a decode threshold of 5. Thus, the DSN address range may include 8 pillar address subranges. At a first time, a first storage unit of the set of storage unit stores 3 pillar address sub-ranges, a second storage unit of the set of storage unit stores 3 pillar address sub-ranges and a third storage unit of the set of storage unit stores 2 pillar address sub-ranges. In this example, the system may determine to only store less than a decode threshold number of pillar address sub-ranges on any one DS unit (e.g., storage unit). At a second time, the computing device determines updated capability level information and determines, based on the updated capability level information, to re-assign a pillar address sub-range from the first storage unit to the third storage unit. For example, the third storage unit's updated capability level information indicates has a forecasting utilization level below a utilization threshold and the first storage unit's updated capability level information indicates an available storage capacity above a storage capacity threshold.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’). In addition, the terms “slice” and “encoded data slice” are used interchangeably.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a computing device of a dispersed storage network (DSN) comprises:
receiving a request to commission a set of storage units for a DSN memory, wherein the request includes a DSN address range and dispersed data storage parameters, wherein the dispersed data storage parameters includes a pillar width number, and wherein the DSN address range is divided into the pillar width number of pillar address sub-ranges;
identifying storage units of the DSN to associate with the DSN address range to produce the set of storage units;
determining whether a number of storage units in the set of storage units is less than the pillar width number; and
when the number of the storage units is less than the pillar width number;
determining capability level information for each storage unit of the set of storage units; and
assigning the pillar width number of pillar address sub-ranges to the set of storage units, wherein the assigning is based on the dispersed data storage parameters, the capability level information, and the number of the storage units.

2. The method of claim 1, wherein the assigning comprises:
assigning, to a first storage unit of the set of storage units, two or more of the pillar address sub-ranges; and
assigning, to remaining storage units of the set of storage units, remaining pillar address sub-ranges of the DSN address range, wherein the two or more pillar address sub-ranges and the remaining pillar address sub-ranges, collectively, are substantially the DSN address range.

3. The method of claim 2 further comprises:
assigning to the first storage unit of the set of storage units, based on the capability level information, first processing responsibilities for a portion of the DSN address range, wherein the portion includes at least some of the two or more pillar address sub-ranges; and
assigning to the remaining storage units of the set of storage units, based on the capability level information, remaining processing responsibilities for a remaining portion of the DSN address range.

4. The method of claim 3, wherein the first and second processing responsibilities includes one or more of:
answering requests at a network location;
servicing authentication requests;
storing data;
performing rebuilding operations; and
responding to list requests.

5. The method of claim 1, wherein the dispersed data storage parameters further include a read threshold number, and wherein the each storage unit of the set of storage units is assigned less than the read threshold number of the pillar address sub-ranges.

6. The method of claim 1, wherein the identifying the storage units includes one or more of:
utilizing a list of candidate storage units included in the request;
obtaining storage unit availability information of the plurality of sets of storage units; and
receiving a query response from the plurality of sets of storage units that includes the capability level information of at least some storage units of the plurality of sets of storage units.

7. The method of claim 1, wherein the capability level information includes one or more of:
available storage capacity;
available task processing capability;
current utilization levels; and
forecasted utilization levels.

8. The method of claim 1 further comprises:
when the number of storage units in the set of storage units is not less than the pillar width number:
assigning, to each storage unit of the set of storage units, a pillar address sub-range of the DSN address range.

9. The method of claim 1 further comprises:
determining to add an additional storage unit to the DSN address range;
identifying another storage unit of the DSN to associate with the DSN address range to produce an updated set of storage units;
determining whether a second number of storage units in the updated set of storage units is less than the pillar width number; and
when the second number of the storage units is less than the pillar width number;
determining updated capability level information for each storage unit of the updated set of storage units; and
re-assigning one or more pillar address sub-ranges to the other storage unit, wherein the assigning is based on the dispersed data storage parameters, the updated capability level information, the number of storage units, and the second number of the storage units.

10. A computing device of a dispersed storage network (DSN) comprises:
a memory;
an interface; and
a processing module operably coupled to the memory and the interface, wherein the processing module is operable to:
receiving a request to commission a set of storage units for a DSN memory, wherein the request includes a DSN address range and dispersed data storage parameters, wherein the dispersed data storage parameters includes a pillar width number, and wherein the DSN address range is divided into the pillar width number of pillar address sub-ranges;
identifying storage units of the DSN to associate with the DSN address range to produce the set of storage units;
determining whether a number of storage units in the set of storage units is less than the pillar width number; and
when the number of the storage units is less than the pillar width number;
determining capability level information for each storage unit of the set of storage units; and
assigning the pillar width number of pillar address sub-ranges to the set of storage units, wherein the assigning is based on the dispersed data storage parameters, the capability level information, and the number of the storage units.

11. The computing device of claim 10, wherein the processing module is operable to perform the assigning by:
assigning, to a first storage unit of the set of storage units, two or more of the pillar address sub-ranges; and
assigning, to remaining storage units of the set of storage units, remaining pillar address sub-ranges of the DSN address range, wherein the two or more pillar address sub-ranges and the remaining pillar address sub-ranges, collectively, are substantially the DSN address range.

12. The computing device of claim 11, wherein the processing module is further operable to:
assign to the first storage unit of the set of storage units, based on the capability level information, first processing responsibilities for a portion of the DSN address range, wherein the portion includes at least some of the two or more pillar address sub-ranges; and
assign to the remaining storage units of the set of storage units, based on the capability level information, remaining processing responsibilities for a remaining portion of the DSN address range.

13. The computing device of claim 12, wherein the first and second processing responsibilities includes one or more of:
answering requests at a network location;
servicing authentication requests;
storing data;
performing rebuilding operations; and
responding to list requests.

14. The computing device of claim 10, wherein the dispersed data storage parameters further include a read threshold number, and wherein the processing module is operable to assign to the each storage unit of the set of storage units, less than the read threshold number of the pillar address sub-ranges.

15. The computing device of claim 10, wherein the processing module is operable to identify the storage units by one or more of:
utilizing a list of candidate storage units included in the request;
obtaining storage unit availability information of the plurality of sets of storage units; and
receiving a query response from the plurality of sets of storage units that includes the capability level information of at least some storage units of the plurality of sets of storage units.

16. The computing device of claim 10, wherein the capability level information includes one or more of:
available storage capacity;
available task processing capability;
current utilization levels; and
forecasted utilization levels.

17. The computing device of claim 10, wherein the processing module is further operable to:
when the number of storage units in the set of storage units is not less than the pillar width number:
assign, to each storage unit of the set of storage units, a pillar address sub-range of the DSN address range.

18. The computing device of claim 10, wherein the processing module is further operable to:
determine to add an additional storage unit to the DSN address range;
identify another storage unit of the DSN to associate with the DSN address range to produce an updated set of storage units;
determine whether a second number of storage units in the updated set of storage units is less than the pillar width number; and
when the second number of the storage units is less than the pillar width number;
determine updated capability level information for each storage unit of the updated set of storage units; and
re-assign one or more pillar address sub-ranges to the other storage unit, wherein the assigning is based on the dispersed data storage parameters, the updated capability level information, the number of storage units, and the second number of the storage units.
